(19) United States
(12) Patent Application Publication
(10) Pub. No.: US 2006/0193280 A1
(43) Pub. Date: Aug. 31, 2006

(54) Relay communication method for an OFDMA-based cellular communication system

(75) Inventors: Yeon-Woo Lee, Seongnam-si (KR); Sang-Boh Yun, Seongnam-si (KR); Seung-Young Park, Yongin-si (KR); Yung-Soo Kim, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/322,121

(22) Filed: Dec. 29, 2005

(30) Foreign Application Priority Data
Dec. 29, 2004 (KR) 115353/2004

(51) Int. Cl. H04J 1/10; H04B 7/14; H04Q 7/00; H04J 3/08; H04J 11/00

(52) U.S. Cl. 370/315; 370/208; 370/328

(57) ABSTRACT

A relay communication method in an orthogonal frequency division multiple access (OFDMA) communication system including at least one base station for providing a multiple access service to a plurality of mobile stations frame by frame. The relay communication method includes dividing a cell defined by transmission power of the base station into a plurality of sectors on the basis of the base station; dividing the cell into an inner area where a first service is supported and an outer area where a second service is supported, on the basis of the base station; arranging at least one relay station in a second service area of each sector; and allocating a partial resource of the frame for communication between the base station and the mobile station through the relay station.

### PRIORITY

This application claims priority under 35 U.S.C. § 119 to an application entitled “Relay Communication Method for OFDMA-Based Cellular Communication System” filed in the Korean Intellectual Property Office on Dec. 29, 2005 and assigned Serial No. 2004-115353, the contents of which are incorporated herein by reference.

### BACKGROUND OF THE INVENTION

1. Field of the Invention

The present invention relates generally to a wireless communication system, and in particular, to a relay communication method for extending a service area by installing a relay station in a shaded area or a cell boundary or by using a mobile station as a relay station.

2. Description of the Related Art

Generally, in an infrastructure wireless communication system such as a wireless local area network (W-LAN), all mobiles stations directly communicate with an access point. Various techniques using intermediate relay stations have been proposed for increasing capacity or energy efficiency of such an infrastructure system.

In this regard, International Publication Number WO 00/54539 discloses “routing in a multi-station network” by introducing the ad hoc networking concept to secure reliability and system capacity of the service area. In the multi-station network routing, a mobile station must operate in both a cellular network and an ad hoc network. More specifically, the mobile station accesses the cellular network via the ad hoc network when it cannot directly access the cellular network or there is a gain by the ad hoc network.

As another example, an integrated cellular and ad-hoc relaying system (i-CAR) has been provided for efficiently performing inter-cell traffic load balancing and channel resource sharing using an ad hoc relay station (ARS) by integrating the cellular system with the ad hoc relay technique.

In the next generation wireless communication system, a Hybrid Duplexing Technique (HDT) combined of Time Division Duplexing (TDD) and Frequency Division Duplexing (FDD) is considered as a scheme for obtaining the synergy effect in terms of performance as well as maintaining the merits of networks in an environment where different networks using different duplexing techniques coexist. However, the foregoing communication systems, which were designed without consideration of the hybrid duplexing technique, cannot be directly applied to the next generation wireless communication system. Therefore, there is a need to design a relay station-based cellular network, which takes into account a resource allocation scheme in the next generation cellular system to which the hybrid duplexing technique will be applied.

In particular, there is a demand for an efficient resource allocation algorithm using a relay station to extend coverage of a high-speed data service and to remove shaded areas in the HDT-based next generation communication system. The efficient resource allocation algorithm is required even in the next generation communication system employing TDD.

### SUMMARY OF THE INVENTION

It is, therefore, an object of the present invention to provide a communication system and method capable of extending coverage of a high-speed data service and removing shaded areas using a relay station designed suitable for a TDD system as well as an HDT system.

It is another object of the present invention to provide a communication system and method capable of minimizing interference and maximizing system performance through sectorization-based cell design and efficient management of resources for a relay station.

To achieve the above and other objects, there is provided a relay communication method in an orthogonal frequency division multiple access (OFDMA) communication system including at least one base station for providing a multiple access service to a plurality of mobile stations frame by frame. The relay communication method includes dividing a cell defined by transmission power of the base station into a plurality of sectors on the basis of the base station; dividing the cell into an inner area where a first service is supported and an outer area where a second service is supported, on the basis of the base station; arranging at least one relay station in a second service area of each sector; and allocating a partial resource of the frame for communication between the base station and the mobile station through the relay station.

### BRIEF DESCRIPTION OF THE DRAWINGS

The above and other objects, features, and advantages of the present invention will become more apparent from the following detailed description when taken in conjunction with the accompanying drawings in which:

FIG. 1 is a conceptual diagram illustrating an operation a relay station (RS) in a communication system according to an embodiment of the present invention;

FIG. 2 is a schematic diagram illustrating an FRS-based relay communication system according to an embodiment of the present invention;

FIG. 3 is a schematic configuration diagram of an FRS-based communication system according to an embodiment of the present invention;

FIGS. 4A and 4B are resource graphs for a description of a resource allocation scheme for the case where a base station communicates with an FRS through a wire or a separate dedicated frequency in an FRS-based communication system according to an embodiment of the present invention;

FIG. 5 is a schematic configuration diagram of an FRS-based communication system according to an embodiment of the present invention;

FIGS. 6A to 6C are resource graphs for a description of a resource allocation scheme for the case where a base station and an FRS use the same radio frequency in an FRS-based communication system according to an embodiment of the present invention;

FIG. 7 is a schematic configuration diagram of an FRS-based communication system according to an embodiment of the present invention;

FIG. 8 is a schematic configuration diagram of an FRS-based communication system with a 3-sector model according to an embodiment of the present invention;

FIG. 9 is a schematic diagram illustrating a cellular communication system using a mobile relay station (MRS) according to an embodiment of the present invention;

FIG. 10 is a schematic configuration diagram of an RS-based communication system using a 6-sector MRS fixed channel allocation scheme according to an embodiment of the present invention;

FIG. 11 is a resource graph for a description of a resource allocation scheme in an MRS-based communication system according to an embodiment of the present invention;

FIG. 12 is a resource graph for a description of a resource sharing/reuse scheme in an MRS-based communication system according to an embodiment of the present invention;

FIG. 13 is a resource graph for a description of an MRS channel reuse scheme in a 3-sector cellular communication system according to an embodiment of the present invention;

FIG. 14 is a schematic system configuration diagram for a description of an MRS fixed channel allocation scheme in a 3-sector cellular system according to an embodiment of the present invention;

FIG. 15 is a resource graph for a description of an MRS fixed channel allocation scheme in a 3-sector cellular communication system according to an embodiment of the present invention;

FIG. 16 is a resource graph for a description of an MRS fixed channel allocation scheme in a 3-sector cellular communication system according to an embodiment of the present invention;

FIG. 17 is a schematic system configuration diagram for a description of an MRS fixed channel allocation scheme in a 3-sector cellular communication system according to an embodiment of the present invention;

FIG. 18 is a resource graph for a description of an MRS fixed channel allocation scheme in a 3-sector cellular communication system according to an embodiment of the present invention;

FIG. 19 is a resource graph for a description of an MRS fixed channel allocation scheme in a 3-sector cellular communication system according to an embodiment of the present invention;

FIG. 20 is a schematic system configuration diagram for a description of another MRS fixed channel allocation scheme in a 3-sector cellular communication system according to an embodiment of the present invention;

FIG. 21 is a resource graph for a description of an MRS fixed channel allocation scheme in a 3-sector cellular communication system according to an embodiment of the present invention;

FIG. 22 is a schematic system configuration diagram of a cellular communication system according to an embodiment of the present invention;

FIG. 23 is a resource graph for a description of a resource allocation scheme in a cellular communication system according to an embodiment of the present invention; and

FIG. 24 is a resource graph for a description of a resource allocation scheme in a cellular communication system according to an embodiment of the present invention.

### DETAILED DESCRIPTION OF THE PREFERRED EMBODIMENTS

Several preferred embodiments of the present invention will now be described in detail herein below with reference to the annexed drawings. In the drawings, the same or similar elements are denoted by the same reference numerals even though they are depicted in different drawings. Further, in the following description, a detailed description of known functions and configurations incorporated herein has been omitted for conciseness.

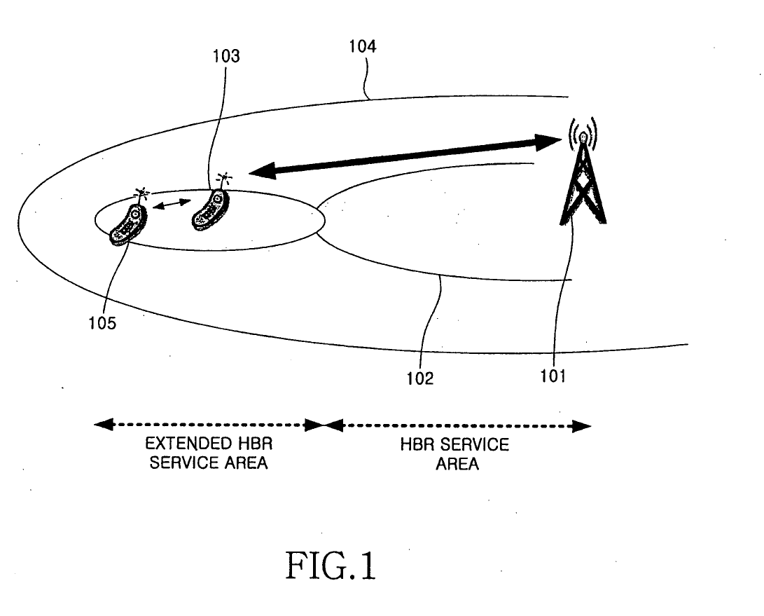

FIG. 1 is a conceptual diagram illustrating an operation of a relay station in a communication system according to an embodiment of the present invention. Referring to FIG. 1, a base station (BS) 101 has an inner area 102 supporting a low mobility and high bit rate (HBR) service and an outer area 104 supporting a high mobility and low bit rate (LBR) service. The outer area 104 is larger than the inner area 102 in radius.

In an HDT system, the base station 101 allocates broadband TDD uplink resources and downlink resources for the inner area 101, and allocates narrowband FDD uplink resources and broadband TDD downlink resources for the outer area 104. However, in a TDD system, the base station 101 allocates broadband TDD uplink resources and downlink resources for the inner area 102 and the outer area 104.

In this basic system configuration, in order to provide an HBR service to a mobile station (MS) 105 located in the outer area 104, a relay station 103 extends an HBR service area limited to the inner area 102 up to the outer area 104. The relay station 103 can be implemented with a fixed relay station (FRS) or a mobile relay station (MRS).

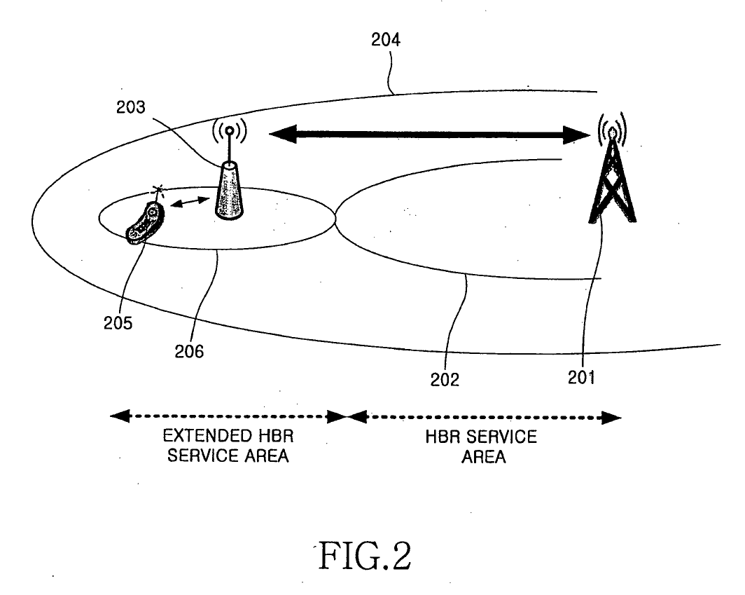

FIG. 2 is a schematic diagram illustrating an FRS-based relay communication system according to an embodiment of the present invention, wherein a base station 201 defines an HBR area 202 with a small radius, an LBR area 204 with a large radius, and the LBR area 204 has a hot spot 206 in which an FRS 203 is installed. The FRS 203 communicates with the base station 201 through a wired or wireless channel, and provides a packet relay service to a mobile station 205 located in the hot spot 206.

By connecting the FRS 203 to the base station 201 through a wired or a separate channel, other than the channel allocated to the base station 201, it is possible to avoid interference from an adjacent cell or an adjacent sector, and there is no need to separately allocate time slots (or time resources). That is, it is possible to avoid channel interference by arranging the FRS 203 in a shaded area or the hot spot 206 and allocating a separate channel being orthogonal with the channel of the base station 201, between the base station 201 and the FRS 203.

However, when the FRS 203 is connected to the base station 201 through the same radio channel, it is possible to avoid channel interference by allocating separate time slots between the FRS 203 and the base station 201.

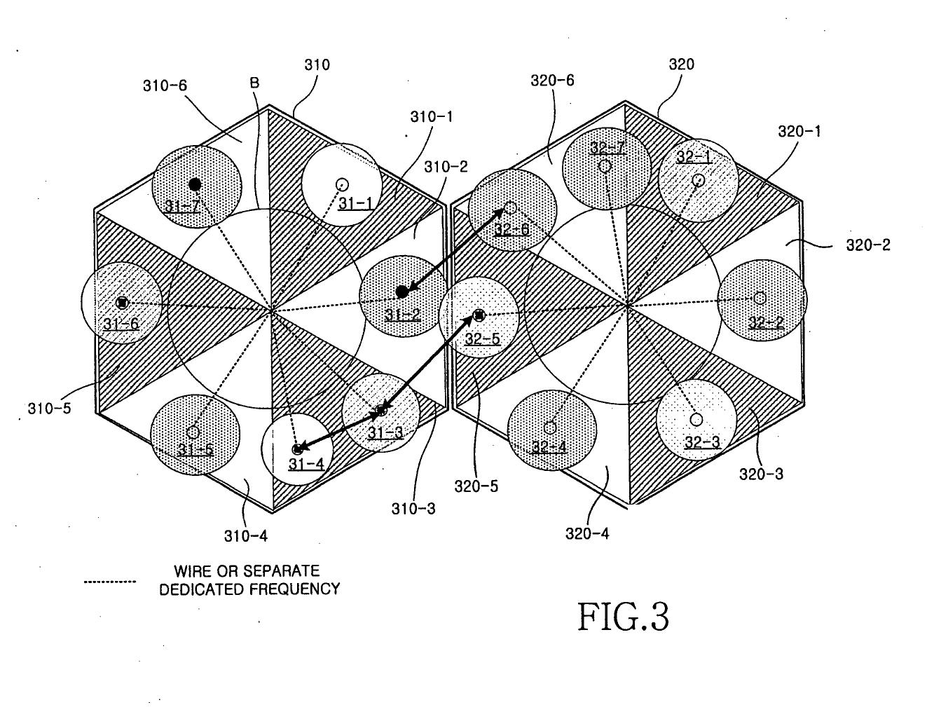

FIG. 3 is a schematic configuration diagram of an FRS-based communication system according to an embodiment of the present invention. Referring to FIG. 3, two HDT systems or two TDD systems (hereinafter referred to as “cells”) 310 and 320 are adjacent to each other, and each cell is divided into 6 sectors 310-1 to 310-6 or 320-1 to 320-6. A given system frequency band is divided into two sub-bands, and the two sub-bands are alternately allocated to the first to sixth sectors 310-1 to 310-6 of the first cell 310 and the first to sixth sectors 320-1 to 320-6 of the second cell 320. The sectors 310-2 and 320-5 located in the boundary of the first cell 310 and the second cell 320 are allocated different sub-bands.

Additionally, each of the cells 310 and 320 is divided into an HBR service area being adjacent to its base station (not shown) and an LBR service area formed at the outer area of the HBR service area by a virtual boundary B. The LBR service area has hot spots 31-1 to 31-7 or 32-1 to 32-7 formed therein by FRSs installed as occasion demands.

By dividing each cell into 6 sectors and allocating different sub-bands (channels) to adjacent sectors in this manner, it is possible to minimize inter-sector interference as well as inter-cell interference.

The hot spots 31-1 to 31-7 and 32-1 to 32-7 have a limited cell radius and are installed in shaded areas for the HBR service. Positions of the hot spots are determined such that they do not interfere with other cells/sectors. Further, adjacent FRSs among the FRSs using the same resource adjust their power levels according to interference distances, thereby adjusting their cell radiuses so that they do not interfere with each other. For example, the hot spots 32-3 and 32-5 using resource #1 decreases their power levels to reduce their cell sizes so that they do not interfere with each other, and the hot spots 31-3, 31-4, and 32-5 maintain their distances through power level adjustment so that no interference occurs therebetween.

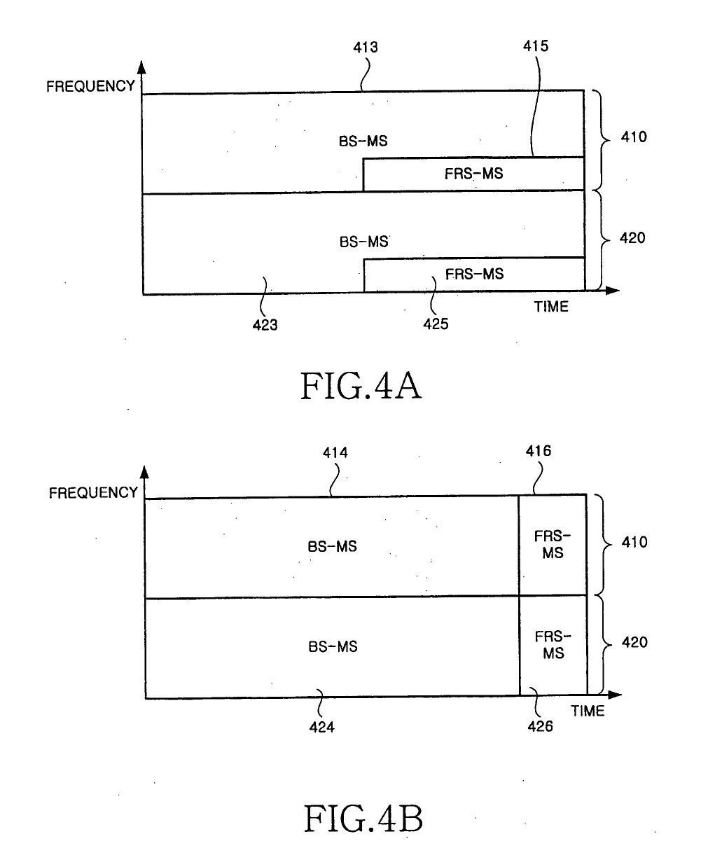

FIGS. 4A and 4B are resource graphs for a description of a resource allocation scheme where a base station communicates with an FRS through a wired or a separate dedicated frequency in an FRS-based communication system according to the an embodiment of the present invention. In FIG. 4A, the full system resource is divided into a first sub-band 410 and a second sub-band 420, and then allocated to their associated sectors of FIG. 3. That is, resources of the first sub-band 410 are allocated to the sectors 310-1, 310-3, and 310-5 of the first cell 310 and the sectors 320-1, 320-3, and 320-5 of the second cell 320, and resources of the second sub-band 420 are allocated to the sectors 310-2, 310-4, and 310-6 of the first cell 310 and the sectors 320-2, 320-4, and 320-6 of the second cell 320. Most of the sub-band resources allocated to each sector are allocated as BS-MS resources 413 and 423 for a downlink from a base station to a mobile station, and a part of the sub-band resources is allocated as FRS-MS resources 415 and 425 for a downlink from an FRS to the mobile station (Partial Frequency Reuse).

As another example, as illustrated in FIG. 4B, each of the sub-bands 410 and 420 undergoes time division, and most of time resources are allocated as BS-MS resources 414 and 424 and a part of the time resources is allocated as FRS-MS resources 416 and 426 (Full Frequency Reuse).

As described above, communication between the base station and the FRS can be achieved through a wired or a separate dedicated channel (indicated by a dotted line).

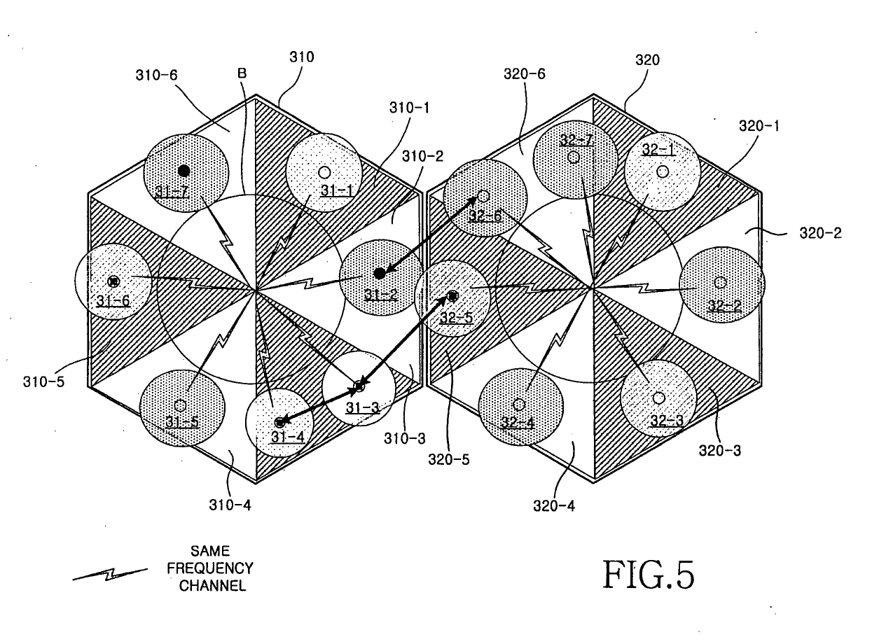

FIG. 5 is a schematic configuration diagram of an FRS-based communication system according to an embodiment of the present invention. Because FIG. 5 is that same as FIG. 3, except that a base station communicates with an FRS using the same radio frequency, the same elements are denoted by the same reference numerals.

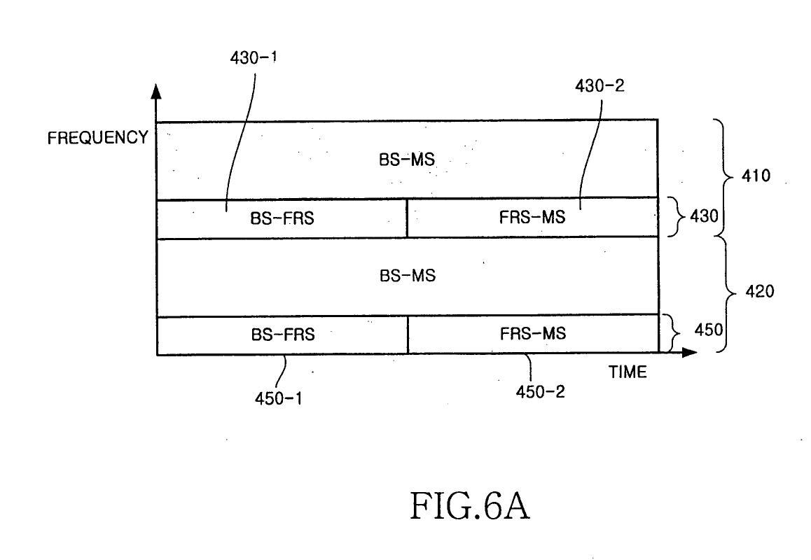

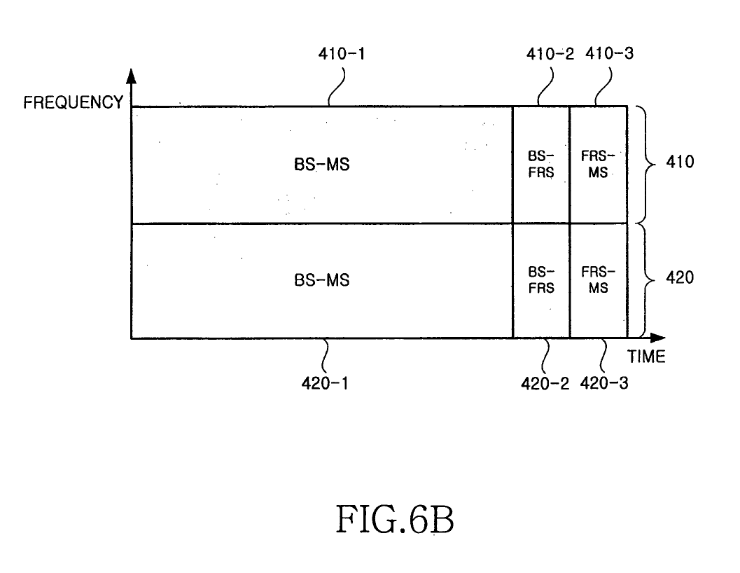

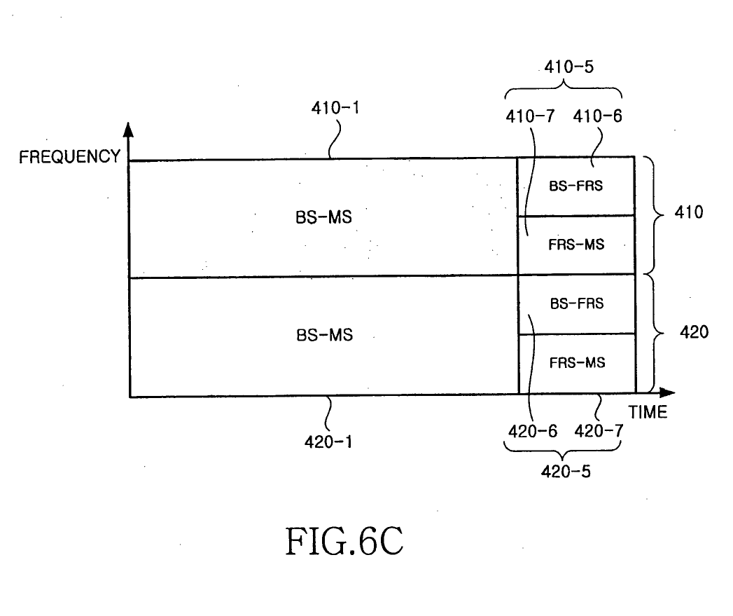

FIGS. 6A to 6C are resource graphs for a description of a resource allocation scheme where a base station and an FRS use the same radio frequency in an FRS-based communication system according to an embodiment of the present invention. Referring FIG. 6A, the full system resource is divided into a first sub-band 410 and a second sub-band 420. Resources of the first sub-band 410 are allocated to the sectors 310-1, 310-3, and 310-5 of the first cell 310 and the sectors 320-1, 320-3, and 320-5 of the second cell 320, and resources of the second sub-band 420 are allocated to the sectors 310-2, 310-4, and 310-6 of the first cell 310 and the sectors 320-2, 320-4, and 320-6 of the second cell 320.

Accordingly, predetermined frequency bands 430 and 450 in the first and second sub-bands 410 and 420 allocated to the sectors are allocated as FRS-only channels. The FRS-only channels 430 and 450 are time-divided into BS-FRS resources 430-1 and 450-1 for communication between the base station and the FRS, and FRS-MS resources 430-2 and 450-2 for communication between the FRS and the mobile station. Therefore, the communication between the base station and the FRS is orthogonal with the communication between the FRS and the mobile station on a time basis, thereby avoiding interference therebetween.

In FIG. 6B, each of the first and second sub-bands 410 and 420 undergoes time division, and the time resources are allocated as BS-MS resources 410-1 and 420-1 for direct communication between the base station and the mobile station, BS-FRS resources 410-2 and 420-2 for communication between the base station and the FRS, and FRS-MS resources 410-3 and 420-3 for communication between the FRS and the mobile station. The foregoing resource allocation uses the same bandwidth and divides the bandwidth for BS-MS communication, BS-FRS communication and FRS-MS communication on a time axis, thereby avoiding interference between the BS-MS communication, the BS-FRS communication and the FRS-MS communication.

In FIG. 6C, the first and second sub-bands 410 and 420 each are time-divided into direct BS-MS resources 410-1 and 420-1 for direct communication between the base station and the mobile station, and relay BS-MS resources 410-5 and 420-5 for relay communication through the FRS. The relay BS-MS resources 410-5 and 420-5 are frequency-divided into BS-FRS resources 410-6 and 420-6 for communication between the base station and the FRS, and FRS-MS resources 410-7 and 420-7 for communication between the FRS and the mobile station. Therefore, the direct BS-MS resources are orthogonal with the relay BS-MS resources on the time axis, and the BS-FRS resources are orthogonal with the FRS-MS resources on the frequency axis, thereby avoiding interference therebetween.

As described above, the communication system according to the present invention can adjust a traffic load between the base station and the FRS in order to actively cope with a variation in traffic environment in the cell due to movement of the mobile station (Load Balancing).

For traffic dispersion, the present invention can increase or decrease time/frequency resources allocated to the FRS according to the amount of traffics required for the FRS. In this case, the present invention maintains the intact size of the hot spot formed by the FRS and increases or decreases resources according to a traffic request based on quality of service (QoS).

An alternative scheme for traffic dispersion maintains the intact resources allocated to the base station and the FRS, and extends or reduces a size of the hot spot which is the HBR service area of the base station and the service area of the FRS. The size of the hot spot can be extended or reduced by controlling transmission power. In this case, the transmission power should be controlled such that no interference occurs between adjacent FRSs. By adjusting an interference level between adjacent cells or between adjacent FRSs, it is possible to control the entire system capacity.

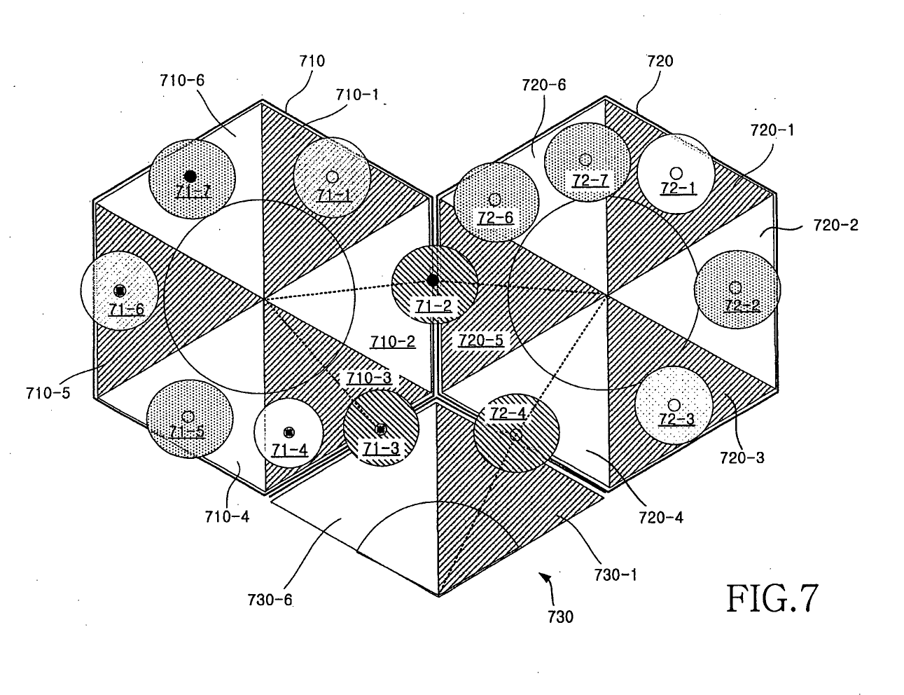

FIG. 7 is a schematic configuration diagram of an FRS-based communication system according to an embodiment of the present invention. In FIG. 7, three cells 710, 720, and 730 are arranged such that they form a boundary. FRSs are installed in the inter-cell boundary, forming hot spots 71-2, 71-3, and 72-4. Among the three cells, the first cell 710 is comprised of sectors 710-1, 710-3, and 710-5, which are allocated a resource #1, and sectors 710-2, 710-4, and 710-6, which are allocated a resource #2. Similarly, the second cell 720 is comprised of first to sixth sectors 720-1 to 720-6, and the third cell 730 is comprised of first to sixth sectors 730-1 to 730-6.

An LBR service area of each cell has a plurality of hot spots 71-1 to 71-7 and 72-1 to 72-7, including the hot spots 71-2, 71-3, and 72-4. The remaining hot spots except for the hot spots 71-2, 71-3, and 71-4 arranged in the inter-cell boundary are allocated a part of the resource #1 or the resource #2 allocated to the cells 710, 720, and 730. The hot spots 71-2, 71-3, and 71-4 located in the inter-cell boundary are allocated a resource #3 being different from the resource #1 and the resource #2, and are commonly controlled by base stations of the cells forming the boundary.

The foregoing resource allocation reserves resources for handover, thereby enabling fast handover. For fast handover, it is preferable for the FRSs located in the boundary to exchange control information with the base stations of the cells forming the boundary through a wire or a separate radio channel. When a plurality of FRSs are installed in the cell boundary, a resource allocated to each FRS can be time-divided and reused, and a mobile station in a hot spot can obtain diversity gain through an FRS that uses several same resources.

The resource sharing scheme in the cell boundary can be implemented for the 6-sector model and also for a 3-sector model.

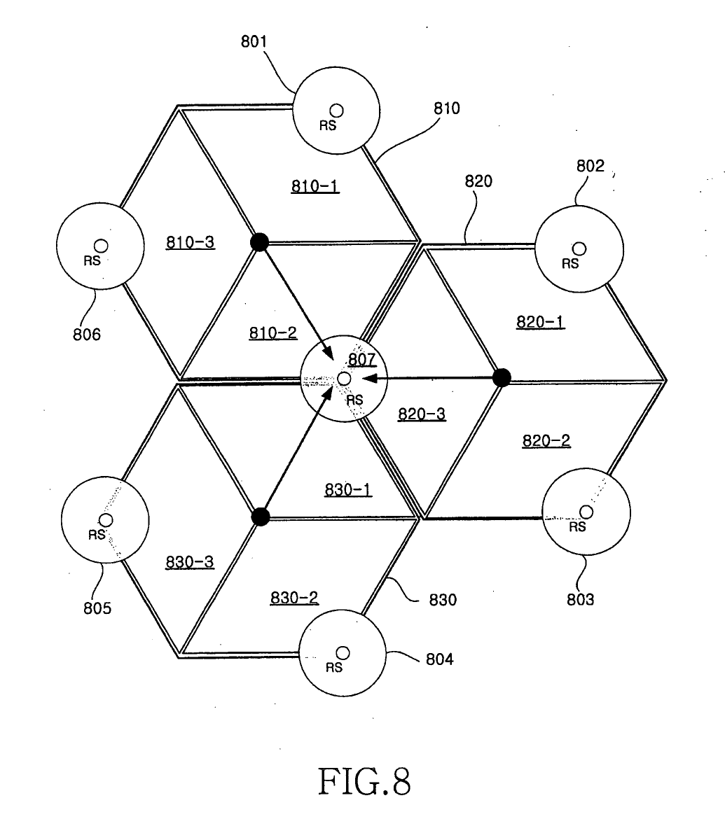

FIG. 8 is a schematic configuration diagram of an FRS-based communication system with a 3-sector model according to an embodiment of the present invention. In FIG. 8, three cells 810, 820, and 830 are arranged forming a boundary, and FRSs are installed in the inter-cell boundary, forming hot spots 801, 802, 803, 804, 805, 806, and 807.

Among the three cells, the first cell 810 is comprised of three sectors 810-1, 810-2, and 810-3 that reuse the same frequency band (for example, a sub-channel set including a sub-carrier #1, a sub-carrier #2 and a sub-carrier #3). Similarly, the second cell 820 and the third cell 830 each are comprised of three sectors 820-1 to 820-3 and 830-1 to 830-3, respectively, all of which reuse the frequency band.

The hot spots 801, 802, 803, 804, 805, 806, and 807 share a separate band (for example, a sub-carrier group #4) being different from the frequency bands allocated to the sectors. In this case, the hot spot 807 located in the boundary of the three cells 810, 820, and 830 are commonly managed by base stations of the three cells 810, 820, and 830.

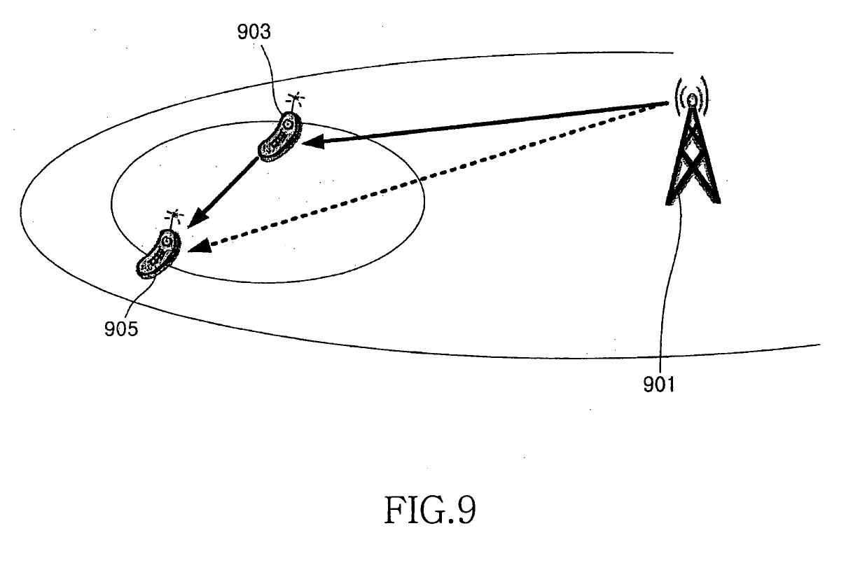

FIG. 9 is a schematic diagram illustrating a cellular communication system using a mobile relay station (MRS) according to an embodiment of the present invention. Referring to FIG. 9, as a mobile station 905 moves to a shaded area, if a channel condition between another adjacent mobile station 901 and a base station 901 is better than the channel condition between the mobile station 905 and the base station 901, the mobile station 903 serves as an MRS.

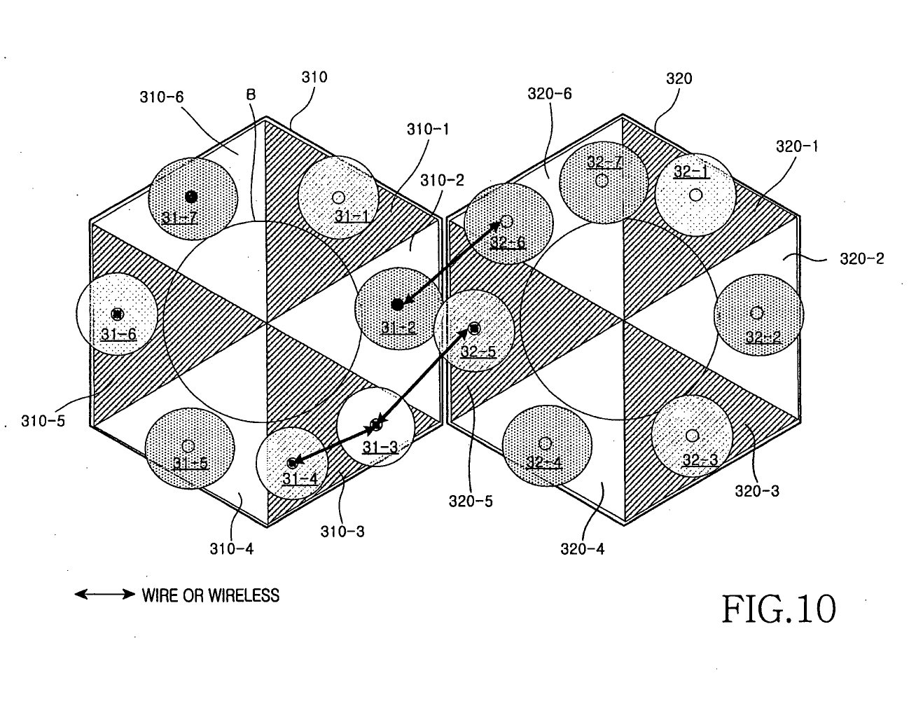

FIG. 10 is a schematic configuration diagram of an RS-based communication system using a 6-sector MRS fixed channel allocation scheme according to an embodiment of the present invention. This embodiment is similar to the embodiment of FIG. 1 in structure of cell, sector, and hot spot, except that the FRS is replaced with the MRS and thus the base station is wirelessly connected to the relay station. Therefore, the same elements are denoted by the same reference numerals.

In FIG. 10, two cells 310 and 320 are adjacent to each other, and each cell is divided into 6 sectors 310-1 to 310-6 or 320-1 to 320-6. Each of the cells 310 and 320 is divided into an HBR service area being adjacent to its base station (not shown) and an LBR service area formed at the outer area of the HBR service area by a virtual boundary B, and the LBR service area has hot spots 31-1 to 31-7 or 32-1 to 32-7 formed therein by FRSs installed as occasion demands.

By dividing each cell into 6 sectors and allocating different sub-bands (channels) to adjacent sectors in this manner, it is possible to minimize inter-sector interference as well as inter-cell interference.

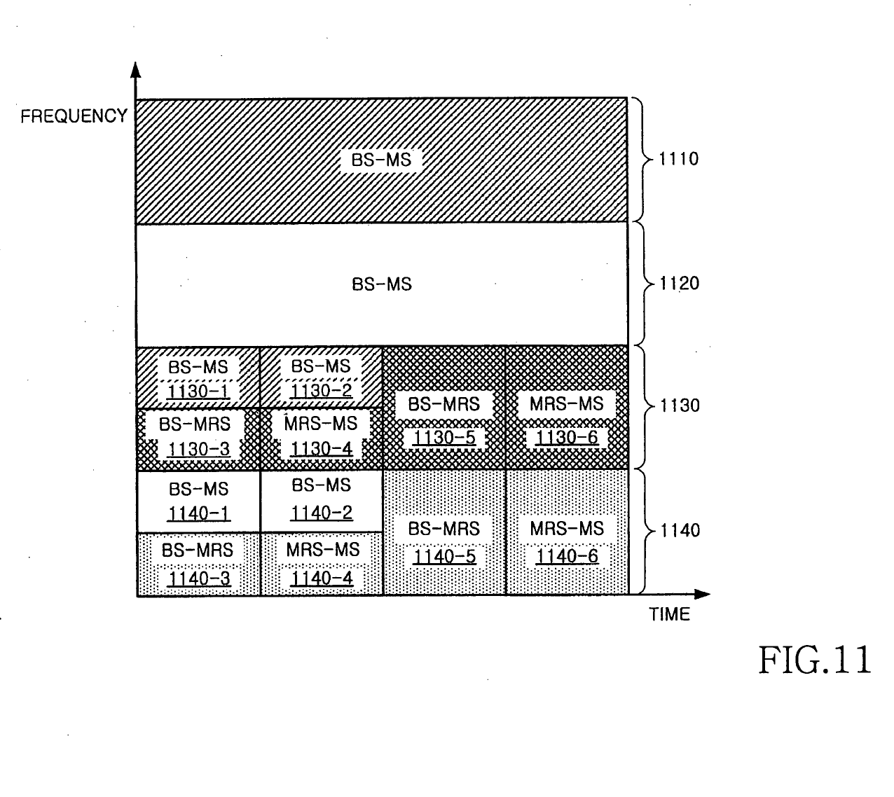

FIG. 11 is a resource graph for a description of a resource allocation scheme in an MRS-based communication system according to an embodiment of the present invention. Referring to FIG. 11, the full system frequency band is divided into four sub-bands 1110, 1120, 1130, and 1140. Among the four sub-bands, the first sub-band 1110 and the second sub-band 1120 are alternately allocated to the cells 310 and 320. That is, the first sub-band 1110 is allocated to odd sectors 310-1, 310-3, and 310-5 of the first cell 310 and odd sectors 320-1, 320-3, and 320-5 of the second cell 320, and the second sub-band 1120 is allocated to even sectors 310-2, 310-4m and 310-6 of the first cell 310 and even sectors 320-2, 320-4m and 320-6 of the second cell 320.

If there is no mobile station requiring a hot spot service, the third sub-band 1130 and the fourth sub-band 1140 each are allocated to odd sectors and even sectors. As a request for the hot spot service increases higher in number, resources of the third sub-band 1130 and the fourth sub-band 1140 are allocated to the corresponding MRS.

That is, for an MRS activated for odd sectors, the third sub-band 1130 is time-divided into BS-MRS resources 1130-3 and 1130-5 for communication between a base station and the MRS, and MRS-MS resources 1130-4 and 1130-6 for communication between the MRS and a mobile station. Similarly, for an MRS activated for even sectors, the fourth sub-band 1140 is time-divided into BS-MRS resources 1140-3 and 1140-5 for communication between the base station and the MRS, and MRS-MS resources 1140-4 and 1140-6 for communication between the MRS and the mobile station.

The BS-MRS resources 1130-3, 1130-5, 1140-3, and 1140-5, and the MRS-MS resources 1130-4, 1130-6, 1140-4, and 1140-6 increase or decrease according to the amount of resources required for MRSs by the mobile station, and the other resources unallocated as the MRS resources remain as the BS-MS resources 1130-1, 1130-2, 1140-1, and 1140-2 for communication between the base station and the mobile station.

Upon moving from an old sector (or cell) to a new sector, the MRS uses the resources allocated for the new sector. For example, if an MRS that was using resources of the sub-band 1140 allocated to an even sector 310-4 of the cell 310 moves to an odd sector 310-3, the MRS communicates with the base station and the mobile station using resources of the sub-band 1130 allocated to the odd sector 310-3. The MRSs in the same sector are allocated different resources, which are orthogonal with each other on the time axis or the frequency axis, or reuse the same resources in such a manner that they secure a reuse distance through power control, such that they suffer no interference from each other.

In addition, when the same frequency resources are used even between the adjacent sectors, the power control is performed taking the interference distance into account.

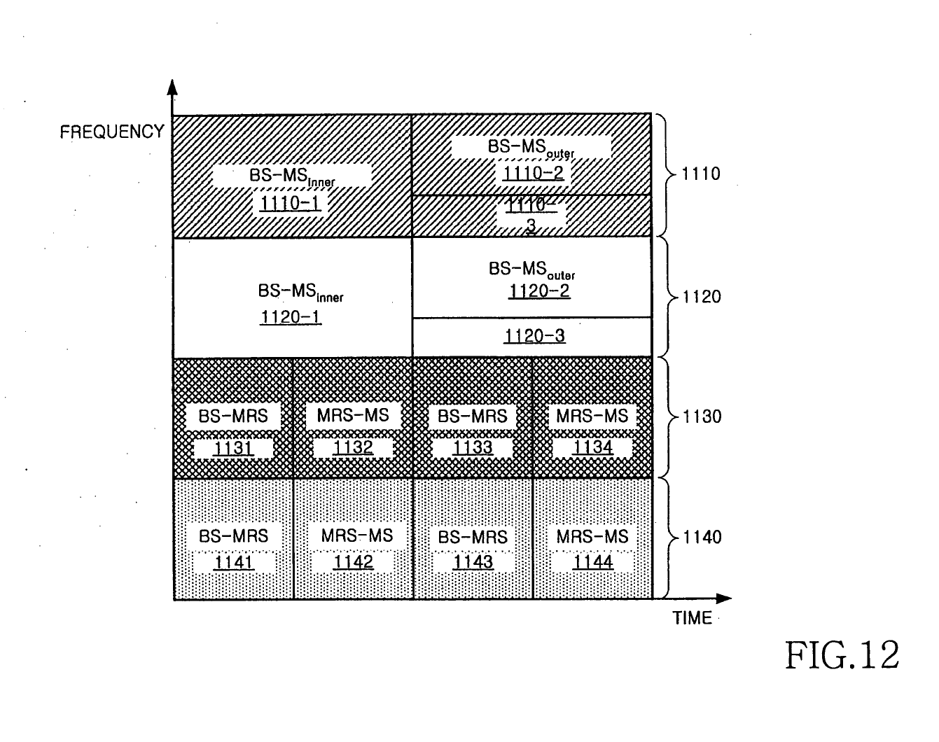

FIG. 12 is a resource graph illustrating a resource sharing/reuse scheme in an MRS-based communication system according to an embodiment of the present invention. Similar to FIG. 11, in FIG. 12, a given system frequency band is divided into four sub-bands 1110, 1120, 1130, and 1140, and each sub-band is time-divided into different resources. The first sub-band 1110 is allocated to odd sectors 310-1, 310-3, and 310-5 of the first cell 310 and odd sectors 320-1, 320-3, and 320-5 of the second cell 320, and the second sub-band 1120 is allocated to even sectors 310-2, 310-4, and 310-6 of the first cell 310 and even sectors 320-2, 320-4, and 320-6 of the second cell 320.

The first and second sub-bands 1110 and 1120 are divided into HBR resources 1110-1 and 1120-1 allocated for an inner area of the corresponding sector, and LBR resources 1110-2 and 1120-2 allocated to an outer area of the sector.

The third and fourth sub-bands 1130 and 1140 are time-divided into BS-MRS resources 1131, 1133, 1141, and 1143 for communication between a base station and an MRS, and MRS-MS resources 1132, 1134, 1142, and 1144 for communication between the MRS and a mobile station, and then allocated to hot spots. More specifically, the third sub-band 1130 is allocated for MRSs located in odd sectors 310-1, 310-3, and 310-5 of the first cell 310 and odd sectors 320-1, 320-3, and 320-5 of the second cell 320, and the fourth sub-band 1140 is allocated for MRSs located in even sectors 310-2, 310-4, and 310-6 of the first cell 310 and even sectors 320-2, 320-4, and 320-6 of the second cell 320.

The BS-MRS resources 1133 and 1143 and the MRS-MS resources 1134 and 1144 in the same time period as the LBR resources 1110-2 and 1120-2 can be dynamically allocated according to the amount of resources required in an outer area of the cell of the MRS. That is, if the BS-MRS resources 1133 and 1143 and the MRS-MS resources 1134 and 1144 are insufficient due to an increase in the resources requested by the MRSs, parts 1110-3 and 1120-3 of the LBR resources 1110-2 and 1120-2 are borrowed. In this embodiment, although MRSs located in odd sectors 310-1, 310-3, 310-5, 320-1, 320-3, and 320-5 borrow a part 1110-3 of the LBR resource 1110-2 for the odd sectors and MRSs located in even sectors 310-2, 310-4, 310-6, 320-2, 320-4, and 320-6 borrow a part 1120-3 of the LBR resource 1120-2 for the even sectors, the present invention should not be restricted to this exact borrowing scheme.

Alternatively, the MRSs located in the odd sectors can also be allocated LBR resources for even sectors and LBR resources for both the odd and even sectors. Similarly, the MRSs located in the even sectors can also be allocated LBR resources for odd sectors and LBR resources for both the odd and even sectors.

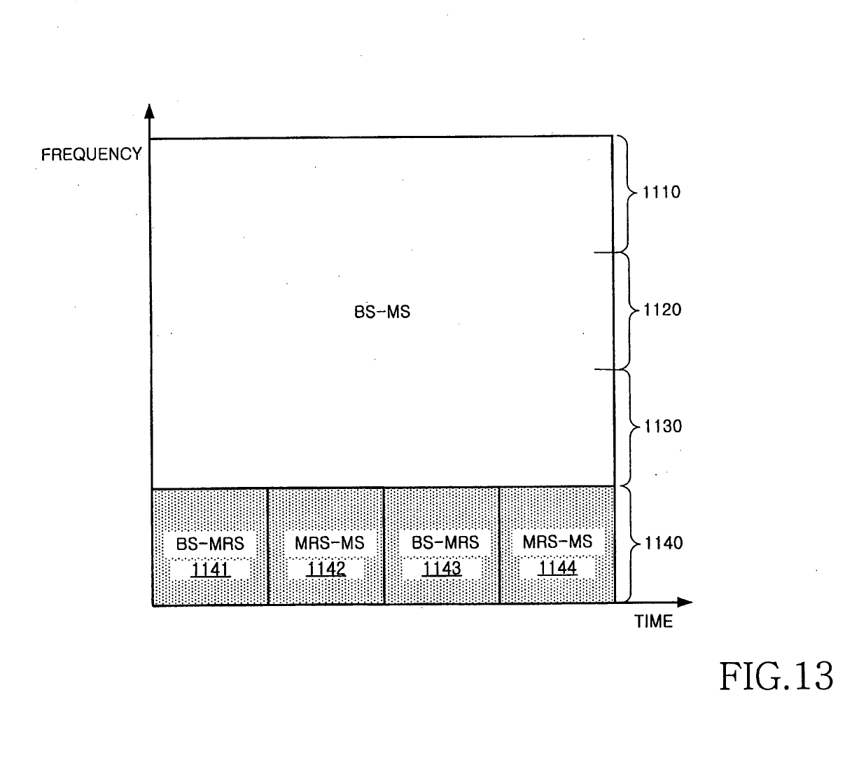

FIG. 13 is a resource graph for a description of an MRS channel reuse scheme in a 3-sector cellular communication system according to an embodiment of the present invention. The MRS-based 3-sector model in FIG. 13 is equal to the FRS-based 3-sector model of FIG. 8 in structure of cell, sector, and hot spot, except that the FRS is replaced with the MRS.

In FIG. 13, among four sub-bands, first, second, and third sub-bands 1110, 1120, and 1130 are reused as BS-MS resources between a base station and a mobile station by sectors 810-1, 810-2, 810-3, 820-1, 820-2, 820-3, 830-1, 830-2, and 830-3 of respective cells, and a fourth sub-band 1140 is reused by MRSs 801, 802, 803,804, 805, 806, and 807. The fourth sub-band 1140 is time-divided into BS-MRS resources 1141 and 1143 for communication between the base station and the MRS and MRS-MS resources 1142 and 1144 for communication between the MRS and the mobile station, and then allocated to each MRS. In this case, base stations of the cells are connected to a radio network controller (RNC, not shown), and manage the MRSs under the control of the RNC. Because a per-sector frequency reuse factor is 1, a mobile station located in a high-resource efficiency cell formed by MRSs obtains diversity gain. In addition, this resource allocation scheme can reserve resources for handover, thereby supporting fast handover of the mobile station in the cell boundary.

When the MRSs have a control function, the resource allocation scheme can reduce a handover process and a handover time by performing handover between MRSs and then reporting the handover to the base station. If the first to third sub-bands 1110, 1120, and 1130 are separately allocated to the sectors, the system can serve as a system with a per-cell frequency reuse factor=1.

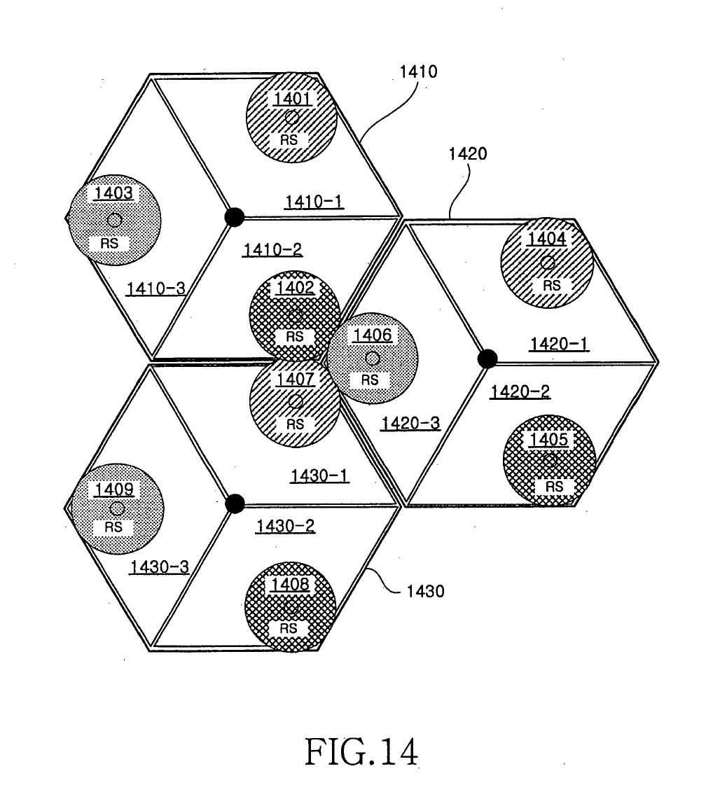

FIG. 14 is a schematic system configuration diagram illustrating an MRS fixed channel allocation scheme in a 3-sector cellular system according to an embodiment of the present invention. In FIG. 14, three sectors 1410, 1420, and 1430 are arranged forming a boundary, and MRSs are installed in the vicinity of the inter-cell boundary, forming hot spots 1401 to 1409. Each cell is sectorized into three sectors. That is, the first cell 1410 is comprised of first to third sectors 1410-1, 1410-2, and 1410-3, the second cell 1420 is comprised of first to third sectors 1420-1, 1420-2, and 1420-3, and the third cell 1430 is comprised of first to third sectors 1430-1, 1430-2 and 1430-3.

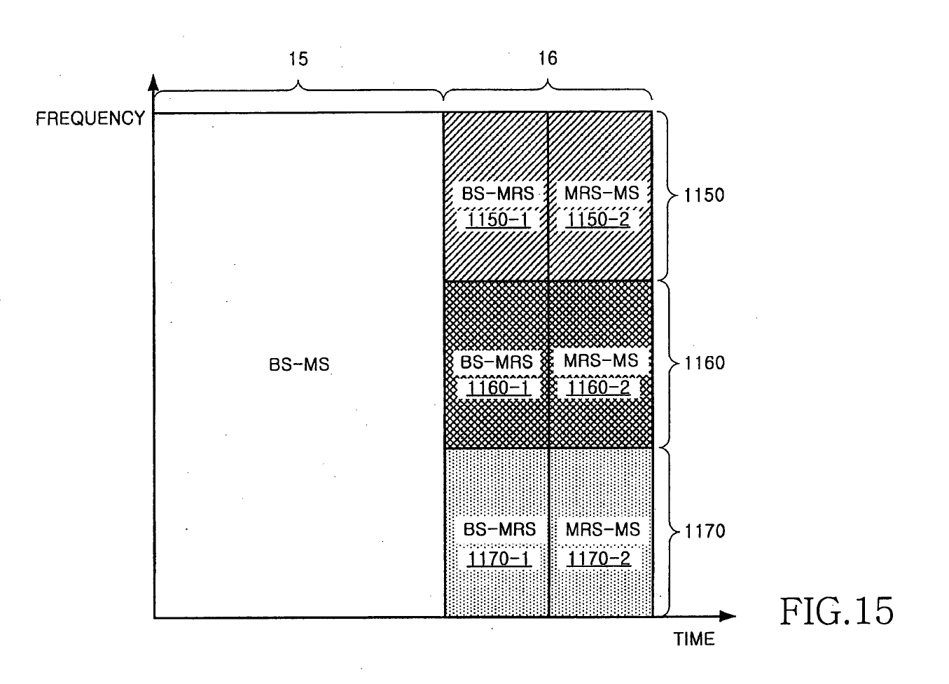

FIG. 15 is a resource graph for a description of an MRS fixed channel allocation scheme in a 3-sector cellular communication system according to an embodiment of the present invention. In FIG. 15, the full system resource is divided into a BS-MS resource 15 for communication between a base station and a mobile station, and an MRS resource 16 for MRS communication. The MRS resource 16 is frequency-divided into first to third sub-bands 1150, 1160, and 1170 on the frequency axis. Each of the sub-bands is divided into BS-MRS resources 1150-1, 1160-1, and 1170-1 for communication between the base station and the MRS, and MRS-MS resources 1150-2, 1160-2, and 1170-2 for communication between the MRS and the mobile station.

Referring to FIGS. 14 and 15, the BS-MS resource 15 is reused in sectors 1410-1, 1410-2, 1410-3, 1420-1, 1420-2, 1420-3, 1430-1, 1430-2, and 1430-3 of the cells 1410, 1420, and 1430. In the MRS resource 16, the first sub-bands 1150 are allocated to hot spots 1401, 1404, and 1407 formed by the MRSs located in first sectors 1410-1, 1420-1, and 1430-1 of the cells, the second sub-bands 1160 are allocated to second sectors 1410-2, 1420-2, and 1430-2 of the cells, and the third sub-bands 1170 are allocated to third sectors 1410-3, 1420-3, and 1430-3 of the cells.

As described above, in the present invention, because the BS-MS resource 15 is orthogonal with the MRS resource 16 on the time axis, it is possible to avoid interference between BS-MS communication, BS-MRS communication, and MRS-MS communication. Further, because adjacent MRSs are allocated resources, which are orthogonal with each other on the frequency axis, it is possible to avoid interference between MRSs (frequency reuse factor=3).

In addition, because the MRS resource is time-divided into the BS-MRS resources and the MRS-MS resources, it is possible to avoid interference between BS-MRS communication and MRS-MS communication. In this case, it is preferable for the sectors to use independent frequency hopping in the same frequency band.

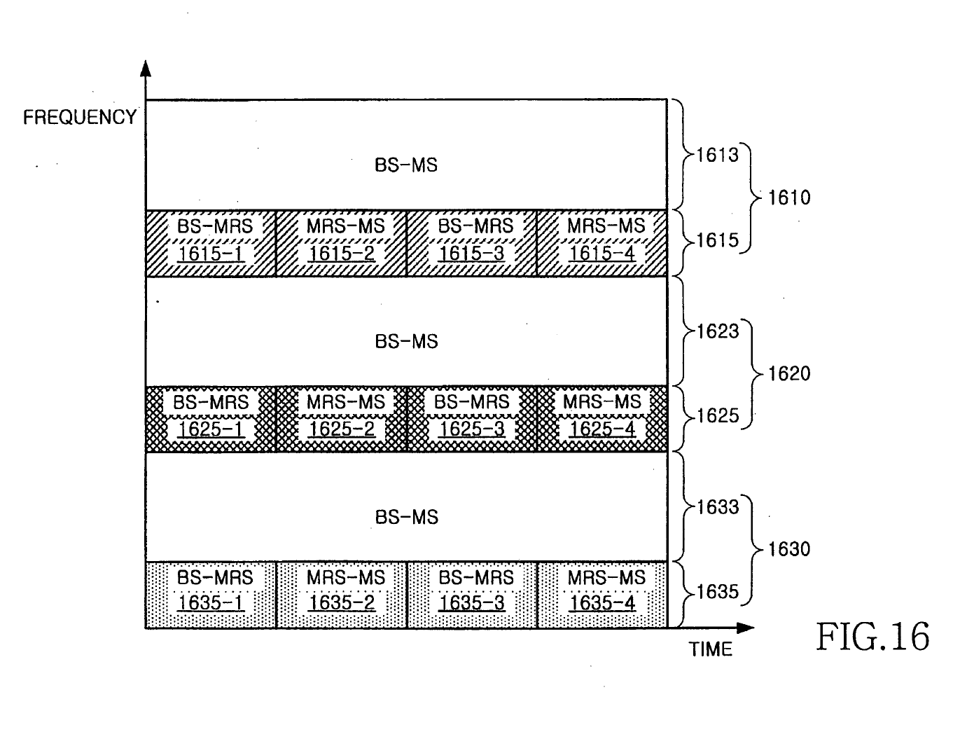

FIG. 16 is a resource graph illustrating an MRS fixed channel allocation scheme in a 3-sector cellular communication system according to an embodiment of the present invention. In FIG. 16, the full system resource is frequency-divided into three sub-bands 1610, 1620, and 1630, and each of the sub-bands is frequency-divided into BS-MS resources 1613, 1623, and 1633 for communication between a base station and a mobile station, and MRS resources 1615, 1625, and 1635 for MRS communication. The MRS resources 1615, 1625, and 1635 each are time-divided into BS-MRS resources 1615-1, 1615-3, 1625-1, 1625-3, 1635-1, and 1635-3 for communication between the base station and the MRS, and MRS-MS resources 1615-2, 1615-4, 1625-2, 1625-4, 1635-2 and 1635-4 for communication between the MRS and the mobile station.

Referring to FIGS. 14 and 16, the BS-MS resources 1613, 1623 and 1633 are reused in sectors 1410-1, 1410-2, 1410-3, 1420-1, 1420-2, 1420-3, 1430-1, 1430-2, and 1430-3 of the cells 1410, 1420, and 1430. The MRS resource 1615 of the first sub-band 1610 is allocated to MRSs, i.e., hot spots 1401, 1404, and 1407, located in first sectors 1410-1, 1420-1, and 1430-1 of the cells, the MRS resource 1625 of the second sub-band 1620 is allocated to MRSs located in second sectors 1410-2, 1420-2, and 1430-2 of the cells, and the MRS resource 1635 of the third sub-band 1630 is allocated to third sectors 1410-3, 1420-3, and 1430-3 of the cells.

In this embodiment of the present invention, because the BS-MS resources 1613, 1623, and 1633 are orthogonal with the MRS resources 1615, 1625, and 1635, it is possible to avoid interference between BS-MS communication, BS-MRS communication, and MRS-MS communication. Further, because adjacent MRSs are allocated resources, which are orthogonal with each other on the frequency axis, it is possible to avoid interference between MRSs.

In addition, because the MRS resources are time-divided into the BS-MRS resources 1615-1, 1615-3, 1625-1, 1625-3, 1635-1, and 1635-3, and the MRS-MS resources 1615-2, 1615-4, 1625-2, 1625-4, 1635-2, and 1635-4, it is possible to avoid interference between BS-MRS communication and MRS-MS communication.

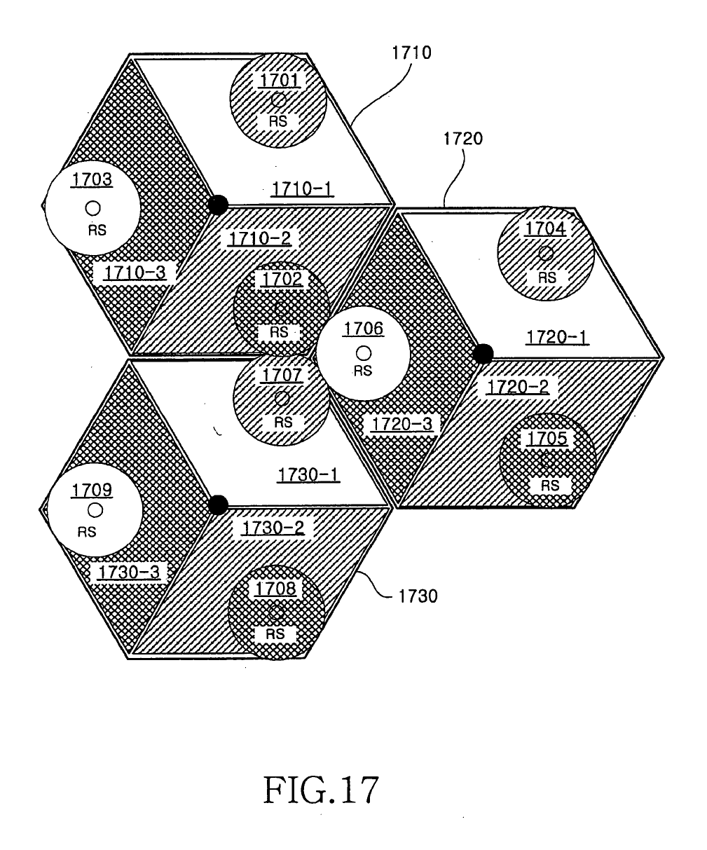

FIG. 17 is a schematic system configuration diagram for a description of an MRS fixed channel allocation scheme in a 3-sector cellular communication system according to an embodiment of the present invention. FIG. 17 is that same as FIG. 16 in system configuration except that independent resources are allocated to the sectors.

Referring to FIG. 17, three cells 1710, 1720, and 1730 are arranged forming a boundary, and MRSs are installed in the vicinity of the inter-cell boundary, forming hot spots 1701 to 1709. Each cell is sectorized into three sectors. That is, the first cell 1710 is comprised of first to third sectors 1710-1, 1710-2, and 1710-3, the second cell 1720 is comprised of first to third sectors 1720-1, 1720-2, and 1720-3, and the third cell 1730 is comprised of first to third sectors 1730-1, 1730-2, and 1730-3. Alternatively, the hot spots where MRSs are located in the cell boundary can be implemented with a single hot spot. For example, the MRSs 1702, 1706, and 1707 can be implemented with a single MRS.

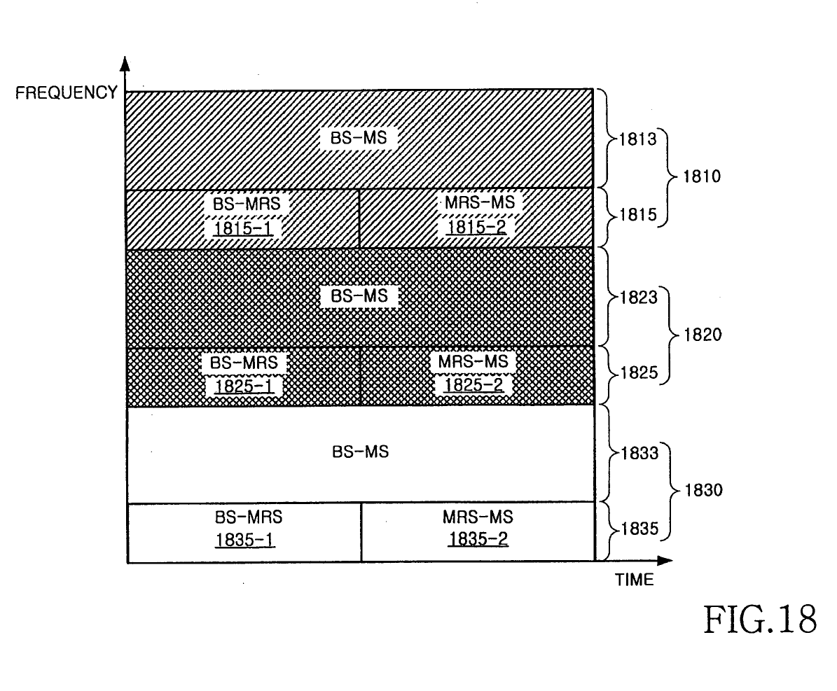

FIG. 18 is a resource graph for a description of an MRS fixed channel allocation scheme in a 3-sector cellular communication system according to an embodiment of the present invention. In FIG. 18, a given system resource is frequency-divided into three sub-bands 1810, 1820, and 1830, and the sub-bands each are frequency-divided again into BS-MS resources 1813, 1823, and 1833 for communication between a base station and a mobile station, and MRS resources 1815, 1825, and 1835 for MRS communication. The MRS resources each are time-divided again into BS-MRS resources 1815-1, 1825-1, and 1835-1 for communication between the base station and the MRS, and MRS-MS resources 1815-2, 1825-2, and 1835-2 for communication between the MRS and the mobile station.

Referring to FIGS. 17 and 18, among the three sub-bands, the BS-MS resource 1813 of the first sub-band 1810 is allocated to the second sectors 1710-2, 1720-2, and 1730-2 of the cells, the BS-MS resource 1823 of the second sub-band 1820 is allocated to the third sectors 1710-3, 1720-3, and 1730-3 of the cells, and the BS-MS resource 1833 of the third sub-band 1830 is allocated to the first sectors 1710-1, 1720-1, and 1730-1 of the cells. Among the three sub-bands, the MRS resource 1815 of the first sub-band 1810 is allocated to the hot spots 1701, 1704, and 1707 located in the first sectors 1710-1, 1720-1, and 1730-1 of the cells, the MRS resource 1825 of the second sub-band 1820 is allocated to the hot spots 1702, 1705, and 1708 located in the second sectors 1710-2, 1720-2, and 1730-2 of the cells, and the MRS resource 1835 of the third sub-band 1830 is allocated to the hot spots 1703, 1706, and 1709 located in the third sectors 1710-3, 1720-3, and 1730-3 of the cells. The MRS resources 1815, 1825, and 1835 are allocated as BS-MRS resources and MRS-MS resources.

In this embodiment of the present invention, because the system resource is divided into three sub-bands and the three sub-bands are independently allocated to the sectors of each cell on a one-to-one basis, it is possible to avoid inter-sector interference. Because the MRS resources allocated to the sectors are orthogonal with each other on the frequency axis, it is possible to avoid inter-MRS interference.

In addition, because the resources for BS-MRS communication are orthogonal with the resources for MRS-MS communication on the time axis, it is possible to avoid interference between the BS-MRS communication and the MRS-MS communication.

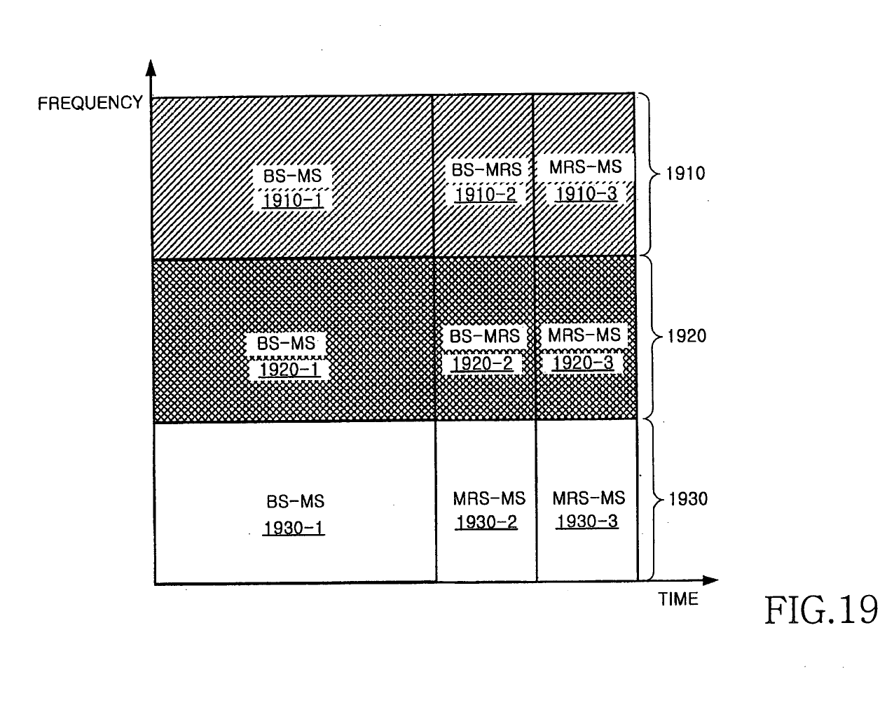

FIG. 19 is a resource graph for a description of an MRS fixed channel allocation scheme in a 3-sector cellular communication system according to an embodiment of the present invention. Referring to FIG. 19, a system resource is frequency-divided into three sub-bands 1910, 1920, and 1930, and the sub-bands each are time-divided into BS-MS resources 1910-1, 1920-1, and 1930-1 for direct communication between a base station and a mobile station, and MRS resources for MRS relay communication. The MRS resources of the sub-bands 1910, 1920, and 1930 are time-divided again into BS-MRS resources 1910-2, 1920-2, and 1930-2 for communication between the base station and the MRS, and MRS-MS resources 1910-3, 1920-3, and 1930-3 for communication between the MRS and the mobile station.

Referring to FIGS. 17 and 19, the BS-MS resource 1910-1 of the first sub-band 1910 is allocated to the second sectors 1710-2, 1720-2, and 1730-2 of the cells, the BS-MS resource 1920-1 of the second sub-band 1920 is allocated to the third sectors 1710-3, 1720-3, and 1730-3 of the cells, and the BS-MS resource 1930-1 of the third sub-band 1930 is allocated to the first sectors 1710-1, 1720-1, and 1730-1 of the cells.

The MRS resources of the first sub-band 1910 are allocated to the hot spots 1701, 1704, and 1707 located in the first sectors 1710-1, 1720-1, and 1730-1 of the cells, the MRS resources of the second sub-band 1920 are allocated to the hot spots 1702, 1705, and 1708 located in the second sectors 1710-2, 1720-2, and 1730-2 of the cells, and the MRS resources of the third sub-band 1930 are allocated to the hot spots 1703, 1706, and 1709 located in the third sectors 1710-3, 1720-3, and 1730-3 of the cells. The MRS resources are time-divided into the BS-MRS resources and the MRS-MS resources.

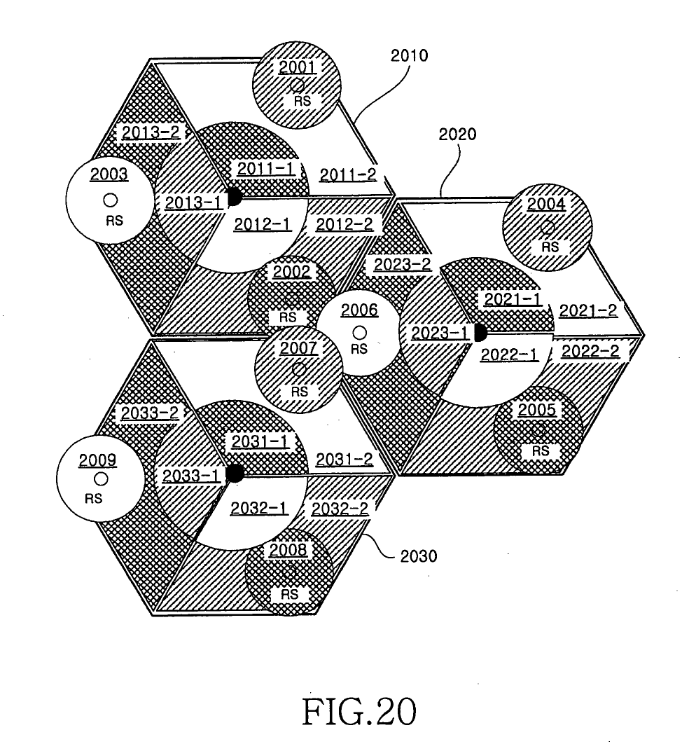

FIG. 20 is a schematic system configuration diagram for a description of another MRS fixed channel allocation scheme in a 3-sector cellular communication system according to an embodiment of the present invention. Referring to FIG. 20, three adjacent cells 2010, 2020, and 2030 each are divided into three sectors, and divided into an inner area (or HBR service area) being adjacent to its base station and an outer area (or LBR service area) surrounding the inner area. More specifically, the first cell 2010 is comprised of a first sector including a first HBR service area 2011-1 and a first LBR service area 2011-2, a second sector including a second HBR service area 2012-1 and a second LBR service area 2012-2, and a third sector including a third HBR service area 2013-1 and a third LBR service area 2013-2, the first to third sectors being formed in different directions on the basis of a base station thereof. The second cell 2020 is comprised of a first sector including a first HBR service area 2021-1 and a first LBR service area 2021-2, a second sector including a second HBR service area 2022-1 and a second LBR service area 2022-2, and a third sector including a third HBR service area 2023-1 and a third LBR service area 2023-2. The third cell 2030 is comprised of a first sector including a first HBR service area 2031-1 and a first LBR service area 2031-2, a second sector including a second HBR service area 2032-1 and a second LBR service area 2032-2, and a third sector including a third HBR service area 2033-1 and a third LBR service area 2033-2. The sectors have MRSs 2001, 2002, 2003, 2004, 2005, 2006, and 2007 located in the respective cell boundaries thereof.

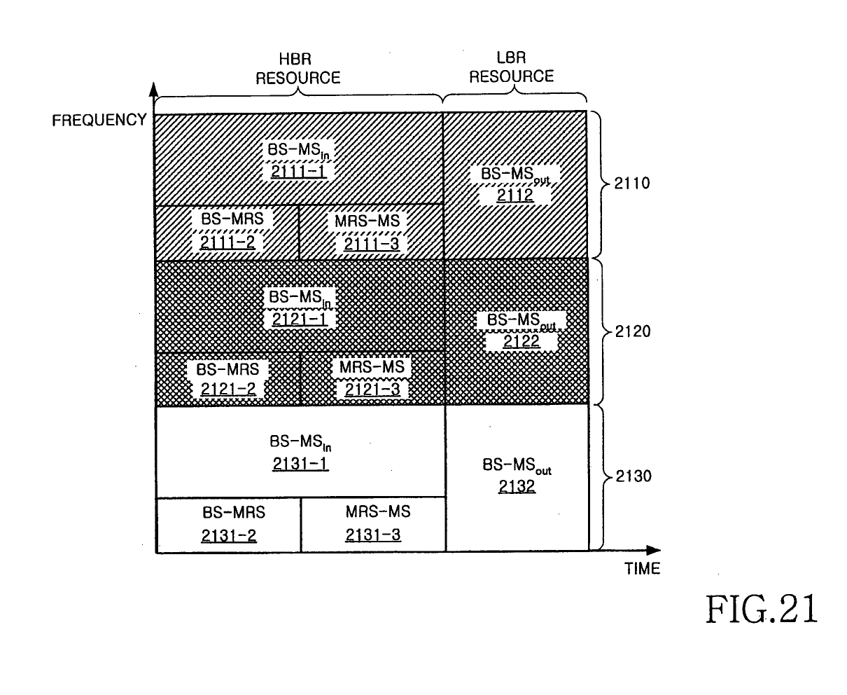

FIG. 21 is a resource graph for a description of an MRS fixed channel allocation scheme in a 3-sector cellular communication system according to an embodiment of the present invention. Referring to FIG. 21, a given system resource is frequency-divided into three sub-bands 2110, 2120, and 2130, and the sub-bands each are time-divided again into an HBR resource and an LBR resource. The HBR resource is frequency-divided into a BS-MS resource for direct communication between a base station and a mobile station located in an inner area of the cell, and an MRS resource for communication through a relay station (RS). The MRS resource is time-divided into a BS-MRS resource for communication between the base station and an MRS and an MRS-MS resource for communication between the MRS and the mobile station.

More specifically, among the three sub-bands, the first sub-band 2110 is time-divided into an HBR resource 2111 and an LBR resource 2112, the second sub-band 2120 is time-divided into an HBR resource 2121 and an LBR resource 2122, and the third sub-band 2130 is time-divided into an HBR resource 2131 and an LBR resource 2132.

The HBR resource 2111 of the first sub-band 2110 is frequency-divided into a BS-MS resource 2111-1 for communication between the base station and the mobile station located in the inner area (HBR service area) of the cell, and an MRS resource for relay communication through the MRS, and the MRS resource is time-divided again into a BS-MRS resource 2111-2 for communication between the base station and the MRS and an MRS-MS resource 2111-3 for communication between the MRS and a mobile station located in a hot spot.

The HBR resource 2121 of the second sub-band 2120 is frequency-divided into a BS-MS resource 2121-1 for communication between the base station and the mobile station located in the inner area of the cell, and an MRS resource for relay communication through the MRS. The MRS resource is time-divided again into a BS-MRS resource 2121-2 for communication between the base station and the MRS and an MRS-MS resource 2121-3 for communication between the MRS and a mobile station located in a hot spot.

The HBR resource 2131 of the third sub-band 2130 is frequency-divided into a BS-MS resource 2131-1 for communication between the base station and the mobile station located in the inner area (HBR service area) of the cell, and an MRS resource for relay communication through the MRS, and the MRS resource is time-divided again into a BS-MRS resource 2131-2 for communication between the base station and the MRS and an MRS-MS resource 2131-3 for communication between the MRS and a mobile station located in a hot spot.

Referring to FIGS. 20 and 21, among the three sub-bands, the BS-MS resource 2111-1 of the first sub-band 2110 is allocated to HBR service areas 2013-1, 2023-1, and 2033-1 of the third sectors of the cells 2010, 2020, and 2030, the BS-MS resource 2121-1 of the second sub-band 2120 is allocated to HBR service areas 2011-1, 2021-1, and 2031-1 of the first sectors of the cells 2010, 2020, and 2030, and the BS-MS resource 2131-1 of the third sub-band 2130 is allocated to HBR service areas 2012-1, 2022-1, and 2032-1 of the second sectors of the cells 2010, 2020, and 2030.

The MRS resources 2111-2 and 2111-3 of the first sub-band 2110 are allocated to the hot spots (or MRSs) 2001, 2004, and 2007 located in the first sectors of the cells, the MRS resources 2121-2 and 2121-3 of the second sub-band 2120 are allocated to the hot spots 2002, 2005, and 2008 located in the second sectors of the cells, and the MRS resources 2131-2 and 2131-3 of the third sub-band 2130 are allocated to the hot spots 2003, 2006, and 2009 located in the third sectors of the cells. The MRS resources each are time-divided into BS-MRS resources 2111-2, 2121-2, and 2131-2 for BS-MRS communication, and MRS-MS resources 2111-3, 2121-3, and 2131-3 for MRS-MS communication.

In this embodiment of the present invention, because the HBR resources allocated to the hot spots for extending the inner areas of the cells for a high-speed data service are orthogonal with the LBR resources allocated to the outer areas of the cells on the time axis, it is possible to avoid interference between the HBR communication and the LBR communication. Because the BS-MS resources for direct communication between the base station and the mobile station are orthogonal with the MRS resources for relay communication on the frequency axis, it is possible to avoid interference between the BS-MS direct communication and the BS-MRS-MS relay communication.

In addition, the BS-MRS communication and the MRS-MS communication are performed through the time-divided resources, thus avoiding interference therebetween.

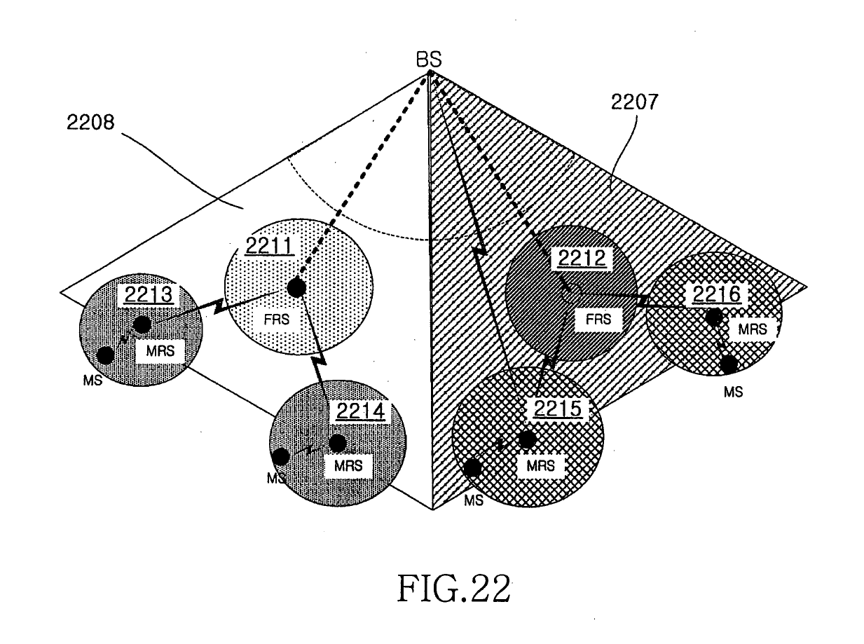

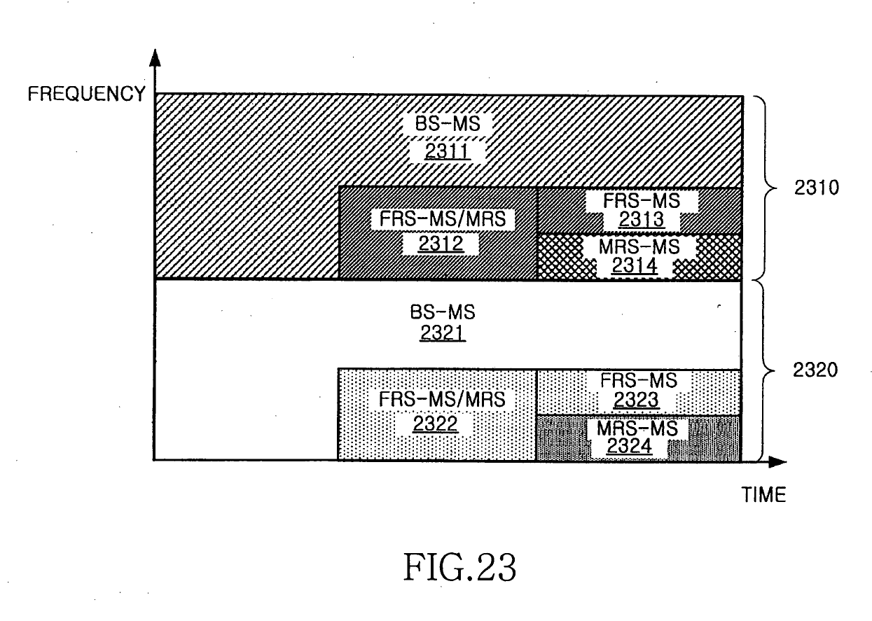

FIG. 22 is a schematic system configuration diagram of a cellular communication system according to an embodiment of the present invention. FIG. 22 shows only two sectors 2208 and 2207 for convenience, in a 6-sector cellular system in which the full system resource is divided into two sub-bands and the two sub-bands are alternately allocated. The sectors each are divided into an inner area for an HBR service and an outer area for an LBR service. The outer areas of the sectors each have one FRS and two MRSs arranged in the cell boundary, forming hot spots 2211, 2212, 2213, 2214, 2215, and 2216.

The base station communicates with the FRSs through a wire or a separate dedicated frequency, and the FRSs are allocated relay resources from the base station. The FRSs allocate a part of the allocated relay resources to the MRSs located in the same sector. The MRSs minimize interference between the hot spots by adjusting the cell size through power control.

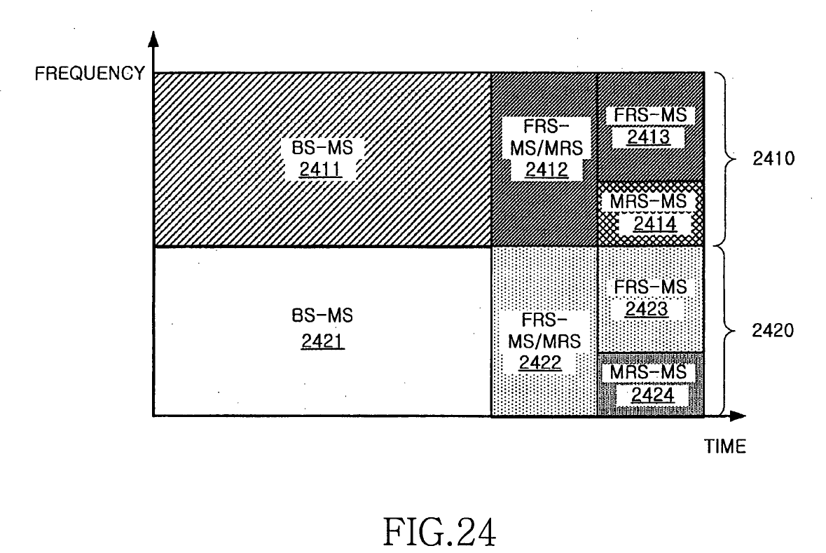

FIG. 23 is a resource graph for a description of a resource allocation scheme in a cellular communication system according to an embodiment of the present invention. Referring to FIG. 23, a given system resource is frequency-divided into a first sub-band 2310 and a second sub-band 2320, and then allocated as direct communication resources 2311 and 2321 for direct communication between a base station and mobile stations in corresponding sectors. If FRSs are installed in the corresponding sectors, parts of the direct communication resources are allocated as relay communication resources 2312, 2313, 2314, 2322, 2323, and 2324 for the FRSs. If the MRSs are activated in the sectors, the relay communication resources are time-divided into FRS-MS/MRS resources 2312 and 2322 for communication between the FRS and the mobile station/MRS, and RS-MS resources 2313, 2314, 2323, and 2324 for communication between the relay station and the mobile station, and the RS-MS resources are frequency-divided into FRS-MS resources 2313 and 2323 for communication between the FRS and the mobile station, and MRS-MS resources 2314 and 2324 for communication between the MRS and the mobile station.

Referring to FIGS. 22 and 23, the BS-MS resource 2311 of the first sub-band 2310 is allocated to the first sector 2207, and the BS-MS resource 2321 of the second sub-band 2320 is allocated to the second sector 2208. If the FRSs are installed in the sectors, forming the first hot spots 2211 and 2212, a part of the BS-MS resource 2311 is allocated to the FRS as the relay communication resources 2312, 2313, and 2314. If the MRSs are activated in the sectors, forming the second hot spots 2213, 2214, 2215, and 2216, the relay communication resources are time-divided into the FRS-MS/MRS resources 2312 and 2322, and the RS-MS resources 2313, 2314, 2323, and 2324. The RS-MS resources are frequency-divided into the FRS-MS resources 2313 and 2323 and the MRS-MS resources 2314 and 2324, and then allocated to the first hot spots 2211 and 2212 and the second hot spots 2213, 2214, 2215, and 2216, respectively.

FIG. 24 is a resource graph for a description of a resource allocation scheme in a cellular communication system according to an embodiment of the present invention. Referring to FIGS. 22 and 24, a given system resource is frequency-divided into a first sub-band 2410 and a second sub-band 2420, and then allocated to the first and second sectors 2207 and 2208, respectively. The sub-bands each are time-divided into direct communication resources 2411 and 2421 for direct communication between the base station and the mobile station, and relay communication resources for relay communication through the RSs, and the relay communication resources are time-divided again into FRS-MS/MRS resources 2412 and 2422 for communication between the FRS and the mobile station/MRS, and RS-MS resources 2413, 2414, 2423, and 2424 for communication between the RS and the mobile station. The RS-MS resources are frequency-divided again into FRS-MS resources 2413 and 2423 for communication between the FRS and the mobile station, and MRS-MS resources 2414 and 2424 for communication between the MRS and the mobile station.

As can be understood from the foregoing description, the novel method extends service coverage of a base station, i.e., HBR service coverage, using fixed or mobile relay stations, thereby improving system performance.

In addition, in the system providing the HBR service and the LBR service based on the HDT and TDD duplexing techniques, the novel method installs a fixed relay station in a shaded area for the HBR service according to traffic variation in the cell, or activates/inactivates the fixed relay station or the mobile relay station in the LBR service area to extend/reduce the HBR service coverage, increasing resource efficiency.

Furthermore, the communication system according to the present invention sectorizes each cell and adaptively allocates resources taking into account characteristics of the sectors and relay stations activated in the sectors, thereby minimizing interference between adjacent cells, sectors, and hot spots.

While the present invention has been shown and described with reference to a certain preferred embodiment thereof, it will be understood by those skilled in the art that various changes in form and details may be made therein without departing from the spirit and scope of the present invention as defined by the appended claims.

What is claimed is:

1. A relay communication method in an orthogonal frequency division multiple access (OFDMA) communication system including at least one base station for providing a multiple access service to a plurality of mobile stations frame by frame, comprising the steps of:
dividing a cell defined by transmission power of the at least one base station into a plurality of sectors;
dividing the cell into an inner area supporting a first service and an outer area supporting a second service;
arranging at least one relay station in a second service area of each sector; and
allocating a partial resource of a frame for communication between the base station and the mobile station through the relay station.

2. The relay communication method of claim 1, wherein the base station communicates with the relay station through one of a wire and a separate dedicated frequency.

3. The relay communication method of claim 2, wherein the frame is divided into a direct communication resource for direct communication between the base station and the mobile station and a relay communication resource for relay communication through the relay station.

4. The relay communication method of claim 3, wherein the relay communication resource is allocated for communication between the relay station and the mobile station.

5. The relay communication method of claim 3, wherein the direct communication resource and the relay communication resource are obtained by time-dividing a same frequency band.

6. The relay communication method of claim 2, wherein the frame is frequency-divided into two sub-bands.

7. The relay communication method of claim 6, wherein the sub-bands are alternately allocated to the sectors of the cell.

8. The relay communication method of claim 7, wherein each of the sub-bands is divided into a direct communication resource for direct communication between the base station and the mobile station and a relay communication resource for relay communication through the relay station.

9. The relay communication method of claim 8, wherein the relay communication resource is allocated for communication between the relay station and the mobile station.

10. The relay communication method of claim 8, wherein the direct communication resource and the relay communication resource are obtained by time-dividing each of the sub-bands.

11. The relay communication method of claim 1, wherein the base station wirelessly communicates with the relay station using a same frequency band.

12. The relay communication method of claim 11, wherein the frame is frequency-divided into a direct communication resource for direct communication between the base station and the mobile station and a relay communication resource for relay communication through the relay station.

13. The relay communication method of claim 12, wherein the relay communication resource is time-divided into a BS-RS resource for communication between the base station (BS) and the relay station (RS), and an RS-MS resource for communication between the relay station and the mobile station.

14. The relay communication method of claim 11, wherein the frame is time-divided into a direct communication resource for direct communication between the base station and the mobile station and a relay communication resource for relay communication through the relay station.

15. The relay communication method of claim 14, wherein the relay communication resource is time-divided into a BS-RS resource for communication between the base station and the relay station and an RS-MS resource for communication between the relay station and the mobile station.

16. The relay communication method of claim 11, wherein the frame is frequency-divided into two sub-bands, and then alternately allocated to the sectors of the cell.

17. The relay communication method of claim 16, where each of the sub-bands is frequency-divided into a direct communication resource for direct communication between the base station and the mobile station and a relay communication resource for relay communication through the relay station.

18. The relay communication method of claim 17, wherein the relay communication resource is time-divided into a BS-RS resource for communication between the base station and the relay station and an RS-MS resource for communication between the relay station and the mobile station.

19. The relay communication method of claim 16, wherein each of the sub-bands is time-divided into a direct communication resource for direct communication between the base station and the mobile station and a relay communication resource for relay communication through the relay station.

20. The relay communication method of claim 19, wherein the relay communication resource is time-divided into a BS-RS resource for communication between the base station and the relay station and an RS-MS resource for communication between the relay station and the mobile station.

21. The relay communication method of claim 19, wherein the relay communication resource is frequency-divided into a BS-RS resource for communication between the base station and the relay station and an RS-MS resource for communication between the relay station and the mobile station.

22. The relay communication method of claim 11, wherein the frame is frequency-divided into four sub-bands.

23. The relay communication method of claim 22, wherein among the four sub-bands, a first sub-band is allocated to odd sectors of the cell and used as a direct communication resource for direct communication between the base station and the mobile station, and a second sub-band is allocated to even sectors of the cell and used as a direct communication resource for direct communication between the base station and the mobile station.

24. The relay communication method of claim 23, wherein among the four sub-bands, a third sub-band is allocated as a relay communication resource for communication between the base station and the mobile station through the relay station in odd sectors, and a fourth sub-band is allocated as a relay communication resource for communication between the base station and the mobile station through the relay station in even sectors.

25. The relay communication method of claim 24, wherein the relay communication resource is used as a direct communication resource when there is no communication between the base station and the mobile station through the relay station of the corresponding sector, and the allocation of the relay communication resource varies according to variation in communication between the base station and the mobile station through the relay station.

26. The relay communication method of claim 25, wherein the relay communication resource is time-divided into a BS-RS resource for communication between the base station and the relay station and an RS-MS resource for communication between the relay station and the mobile station.

27. The relay communication method of claim 23, wherein the direct communication resource is time-divided into an inner direct communication resource allocated for direct communication in the inner area and an outer direct communication resource allocated for direct communication in the outer area.

28. The relay communication method of claim 27, wherein among the four sub-bands, a third sub-band is allocated as a relay communication resource for communication between the base station and the mobile station through the relay communication in the odd sector, and a fourth sub-band is allocated as a relay communication resource for communication between the base station and the mobile station through the relay station in the even sector.

29. The relay communication method of claim 28, wherein the relay communication resource is time-divided into a BS-RS resource for communication between the base station and the relay station and a relay communication resource for communication between the relay station and the mobile station.

30. The relay communication method of claim 29, wherein if the relay communication resource is insufficient, a part of the outer direct communication resource is borrowed.

31. The relay communication method of claim 22, wherein among the four sub-bands, first, second, and third sub-bands are allocated to the sectors and used as direct communication resources for direct communication between the base station and the mobile station, and a fourth sub-band is allocated as a relay communication resource for communication between the base station and the mobile station through the relay station in each sector.

32. The relay communication method of claim 31, wherein the relay communication resource is time-divided into a BS-RS resource for communication between the base station and the relay station and an RS-MS resource for communication between the relay station and the mobile station.

33. The relay communication method of claim 11, wherein the frame is time-divided into a direct communication resource for direct communication between the base station and the mobile station and a relay communication resource for relay communication through the relay station.

34. The relay communication method of claim 33, wherein the direct communication resource is allocated to each sector.

35. The relay communication method of claim 34, wherein the relay communication resource is frequency-divided into three bands and then allocated to adjacent sectors as band relay communication resources.

36. The relay communication method of claim 35, wherein each of the band relay communication resources is time-divided into a BS-RS resource for communication between the base station and the relay station and an RS-MS resource for communication between the relay station and the mobile station.

37. The relay communication method of claim 11, wherein the frame is frequency-divided into three sub-bands.

38. The relay communication method of claim 37, wherein each of the sub-bands is frequency-divided into a direct communication resource for direct communication between the base station and the mobile station, and a relay communication resource for relay communication through the relay station.

39. The relay communication method of claim 38, wherein the direct communication resources of the sub-bands are reuse-allocated to each sector and the relay communication resources are allocated to different sectors.

40. The relay communication method of claim 39, wherein the relay communication resource is time-divided into a BS-RS resource for communication between the base station and the relay station and an RS-MS resource for communication between the relay station and the mobile station.

41. The relay communication method of claim 38, wherein the direct communication resources are allocated to the different sectors for each sub-band, the relay communication resources are also allocated to the different sectors for each sub-band, and the direct communication resource and relay communication resource of different sub-bands are allocated to a same sector.

42. The relay communication method of claim 41, wherein the relay communication resource is time-divided into a BS-RS resource for communication between the base station and the relay station and an RS-MS resource for communication between the relay station and the mobile station.

43. The relay communication method of claim 37, wherein each of the sub-bands is time-divided into a direct communication resource for direct communication between the base station and the mobile station and a relay communication resource for relay communication through the relay station.

44. The relay communication method of claim 43, wherein the direct communication resources are allocated to the different sectors for each sub-band, the relay communication resources are also allocated to the different sectors for each sub-band, and the direct communication resource and relay communication resource of different sub-bands are allocated to a same sector.

45. The relay communication method of claim 44, wherein the relay communication resource is time-divided into a BS-RS resource for communication between the base station and the relay station and an RS-MS resource for communication between the relay station and the mobile station.

46. The relay communication method of claim 37, wherein each of the sub-bands is time-divided into a high bit rate (HBR) resource for HBR data transmission and a low bit rate (LBR) resource for LBR data transmission.

47. The relay communication method of claim 46, wherein the LBR resource is frequency-divided into an inner BS-MS resource for communication between the base station and the mobile station in the inner area and a relay communication resource for relay communication through the relay station.

48. The relay communication method of claim 46, wherein the relay communication resource is time-divided into a BS-RS resource for communication between the base station and the relay station and an RS-MS resource for communication between the relay station and the mobile station.

49. The relay communication method of claim 48, wherein the inner BS-MS resources are allocated to the inner areas of different sectors, the relay communication resources are also allocated to the different sectors, and the inner BS-MS resources and relay communication resources of the different sub-bands are allocated to a same sector.

50. The relay communication method of claim 49, wherein the LBR resource includes a sub-band resource that is allocated to the inner area and is different from an inner BS-MS resource and a relay communication resource of a corresponding sector.

51. The relay communication method of claim 11, wherein the relay station is a fixed relay station.

52. The relay communication method of claim 11, wherein the relay station is a mobile relay station.

53. The relay communication method of claim 11, wherein the relay station is a mobile station having a relay function.

54. The relay communication method of claim 11, wherein when both a fixed relay station and a mobile relay station are located in one sector, a part of a resource allocated to the fixed relay station is allocated as a resource for relay communication through the relay station.
